(19) United States
(12) Patent Application Publication
(10) Pub. No.: US 2006/0279954 A1
(43) Pub. Date: Dec. 14, 2006

(54) Pendant lamp fixture

(75) Inventor: Roger Sherman, Chelsea, MA (US)

Correspondence Address: TODD S. PARKHURST;HOLLAND & KNIGHT LLP, 131 S. DEARBORN STREET, 30TH FLOOR, CHICAGO, IL, 60603, US

(73) Assignee: Tensor Corporation

(21) Appl. No.: 11/150,006

(22) Filed: Jun. 10, 2005

(51) Int. Cl. F21V 17/00

(52) U.S. Cl. 362/353; 362/442

(57) ABSTRACT

A pendant lamp is disclosed. The lamp includes a lamp wire and a socket for receiving an illuminating lamp bulb, first connection means for connection to a large lampshade spider ring, and second connection means for connection to a small lamp shade spider ring. The second connection means includes fittings adapted to route the lamp wire without interruption around the small lampshade spider ring.

This invention relates generally to pendant lamp fixtures, and more particularly, concerns a pendent lamp fixture which will mount either of two standard lampshade spider rings.

### BACKGROUND OF THE INVENTION

Pendant lamps, i.e., lamps which hang from a ceiling or other elevated support by a chain, cable, or even from a power cord, have long been popular illumination devices in homes and elsewhere.

Recently, commercial interest has been shown in pendant lamps which provide a light bulb or other source of illumination and which support a lampshade of more or less usual truncated conical or cylindrical shape. Under normal circumstances, standard lamps mount such standard lampshades. Many such lamp shade designs are available. Most such lampshades have an outer ring which supports the lampshade fabric or other material, and a so-called spider consisting of three or more radially inwardly extending rods which are connected from the outer ring to a central inner ring. These inner rings are generally of either a standard large diameter or a generally standard small diameter. The rings, and thus the lampshades, can be easily attached to almost any type of standard freestanding floor lamp, desk lamp or table lamp. As is well-known, the lamp stand or base usually supports a socket for receiving a light bulb or other illumination device, and extending from the socket and around the light bulb is a so-called harp. At the top of the harp is a finial which is sized and shaped to accept and support the lampshade inner ring.

It has been difficult or impossible to use this standard lamp arrangement for a pendant lamp, because the lamp parts and their relative positions are inverted.

It is the general object of the present invention to provide a pendant lamp having an inverted bulb socket and other parts arranged so that a lampshade can be attached to the lamp in a proper and customary lampshade orientation and position surrounding the lamp bulb.

It is another object of the invention to provide apparatus for attaching either a large central lampshade ring or a small central lampshade ring to a pendant lamp so that both the pendant lamp structure and the lampshade are oriented and configured properly.

Other objects and advantages of the invention will become apparent upon reading the following detailed description and upon reference to the drawings. Throughout the drawings, like reference numerals refer to like parts.

### BRIEF DESCRIPTION OF THE DRAWINGS

FIG. 1 is an exploded view of an embodiment of the invention.

FIG. 2 is an isometric view of the invention as it appears when the invention supports a lampshade having a large central support ring.

FIG. 3 is an isometric view of the invention as it appears when the invention supports a lampshade having a small central support ring.

### DETAILED DESCRIPTION

While the invention will be described in connection with a preferred embodiment, it will be understood that it is not intended to limit the invention to this embodiment. On the contrary, it is intended to cover all alternatives, modifications and equivalents as may be included within the spirit and scope of the invention as defined by the appended claims.

A pendant lamp embodying the invention is shown in each of the drawings. In the illustrated embodiment, this lamp 10 includes a power cord 12 having a standard wall plug 13 and a switch 14, which can be of the off-on variety. It is contemplated that this cord 12 will be connected to an ordinary wall socket, and will be fastened, by any known means, to the adjacent wall and along a ceiling or other overhead structure to a convenient place from which the lamp is to be hung.

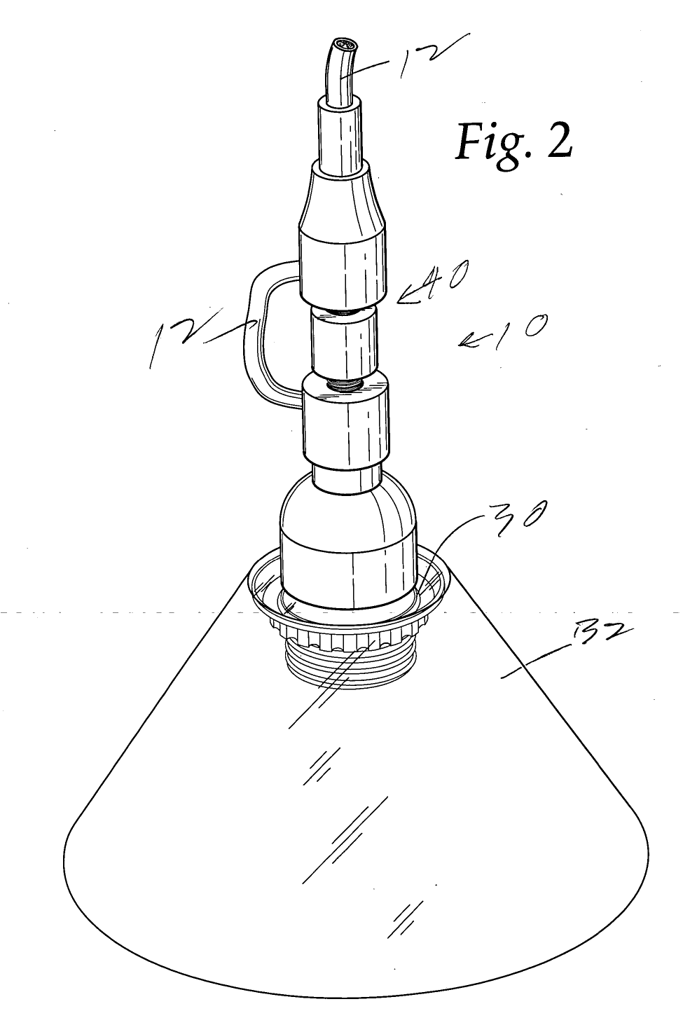

The lamp assembly 20 here includes a bi-ended socket 22 for receiving an illuminator such as an ordinary incandescent electric light bulb to mount a lampshade. At a first end 24 of the bi-ended socket 22, in accordance with the invention, a first lampshade connection means comprises a helical socket thread 26 and a retaining ring 27. The ring 27 has a mating thread 28 and a toroidal spider ring engagement element 29 for engaging the large spider ring 30 of a lampshade 32 (FIG. 2). A light bulb (not shown) can be screwed into the socket 22 after the lampshade 32 is installed on the first socket end 24.

The second lampshade connection means 40 is mounted above the socket 22. To permit a lampshade to be mounted on the lamp 10 without interrupting its wire or power cord 12 in accordance with another aspect of the invention, this second connection means 40 includes a first fitting 42 which is adapted to carry the electric wire 12 into and through a fitting inlet end 23 and out a fitting outlet side 44 in a direction at an angle to the fitting end 43. A second fitting 46 is adapted to carry the electric wire 12 into and through a second fitting inlet 47 and out a fitting outlet end 48 and fence into the socket 22. Thus the wire 12 extends around and outside the fittings 40 and 46 in a U-shaped configuration.

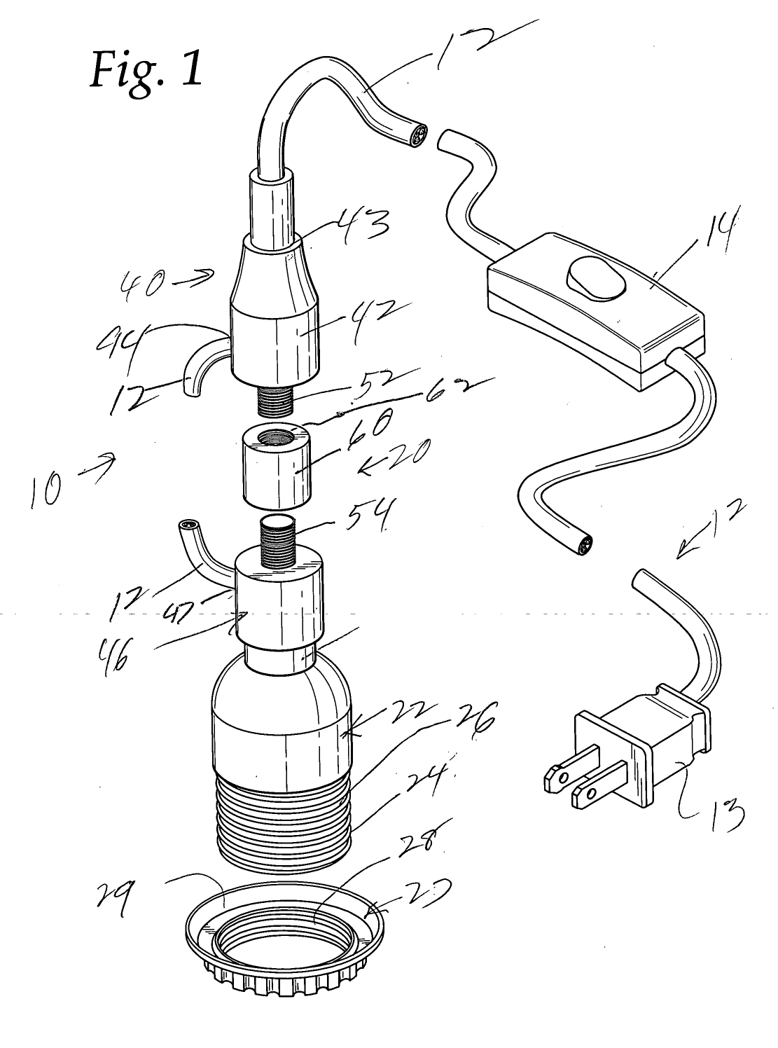

The first fitting 42 carries a first stud 52 in a position substantially coaxial with a first fitting inlet end 43, and the setting fitting carries a second stud 54 in a position substantially coaxial with the second fitting 46 and its outlet end, and selectively substantially coaxial with the first stud 52 mounted in and on the first fitting 40 as particularly shown in FIG. 1.

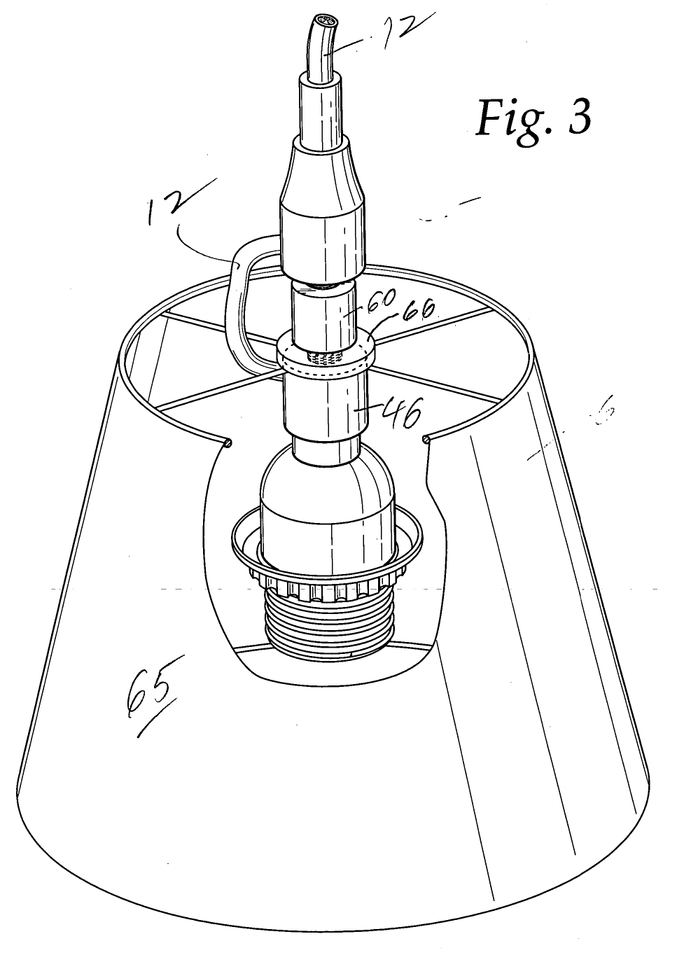

As particularly illustrated in FIG. 1, the studs 52 and 54 are threaded, and a bushing 60 having internal threads 62 selectively interconnects the stud 52 and 54 and, hence, the first and second fittings 40 and 46. When it is desired to mount a lampshade 65 having a relatively small center ring 66 as illustrated in FIG. 3, in accordance with the invention, the bushing 60 can be rotated so as to cause it to travel up the stud 52 and out of engagement with the stud 54 so as to leave a gap for the lampshade center ring 66 to be inserted into position as shown in FIG. 3. The stud 60 is then turned back into engagement with the lower stud 54 so as to clamp the center ring 66 between the stud 60 and the second fitting 46 as illustrated in FIG. 3.

In accordance with the invention, the electric power cord and wire 12 is not cut or interrupted, and need not be provided with interconnecting plugs of any sort. Rather, the wire 12 simply bypasses and is routed around the lampshade mounting mechanism 66 described above.

The following is claimed as invention:

1. A lamp, comprising, in combination,
a socket for receiving an illuminator,
first connection means for connection to a large lampshade spider ring and second connection means for connection to a small lampshade spider ring.

2. A lamp according to claim 1 wherein said socket has a bi-ended base, and wherein the first connection means is at one socket end and the second connection means is at the other socket end.

3. A lamp according to claim 2 wherein said first connection means comprises a helical socket thread, a retaining ring having a mating thread for connection to the socket connection thread, and a spider ring engagement element for engaging the large spider ring.

4. A lamp according to claim 3 wherein said helical socket thread is formed on the outer socket surface.

5. A lamp according to claim 1 wherein said second connection means comprises a first fitting adapted to carry an electric wire into and through a fitting inlet end and out one outlet side in a direction at an angle to the fitting end.

6. A lamp according to claim 6 wherein said first fitting also carries a first stud in a position substantially coaxial with the first fitting inlet end.

7. A lamp according to claim 1 wherein said second connection means further comprises a second fitting adapted to carry the electric wire into and through a fitting inlet and out a fitting outlet end.

8. A lamp according to claim 7 wherein said second fitting also carries a second stud in a position substantially coaxial with the second fitting outlet end and selectively substantially coaxial with a first stud mounted in and on a second connection first fitting.

9. A lamp according to claim 8 wherein said second fitting outlet end is joined to said socket.

10. A lamp according to claim I wherein said second connection means comprises
a first fitting adapted to carry an electric wire and mounting a first stud, and
a second fitting adapted to carry an electric wire and mounting a second stud,
the first and second fittings being adapted to be arrayed so that the first and second studs can be arranged in a confronting, separated, coaxial configuration.

11. A lamp according to claim 10 wherein said first and second studs are threaded, and wherein the lamp further comprises a threaded bushing for interconnecting the first and second studs.

12. A lamp according to claim 11 wherein said bushing is adapted to clamp a spider ring between the bushing and a fitting.

13. A lamp, comprising, in combination,
a bi-ended socket for receiving an illuminator,
first connection means at one socket end for connection to a large lampshade spider ring and second connection means at the other socket end for connection to a small lampshade spider ring.

14. A lamp according to claim 13 wherein said first connection means comprises a retaining ring for connection to the socket end for engaging and retaining a large lamp shade spider ring.

15. A lamp according to claim 13 wherein said second connection means comprises a first fitting having a first stud in a position substantially coaxial with said socket.

16. The lamp according to claim 13 wherein said second connection means further comprises a second fitting having a second stud in a position selectively substantially coaxial with said first stud.

17. A lamp according to claim 1 wherein said second connection means comprises
a first fitting adapted to carry an electric wire and mounting a first stud, and
a second fitting adapted to carry an electric wire and mounting a second stud,
the first and second fittings being adapted to be arrayed so that the first and second studs can be arranged in a confronting, separated, co-axial configuration.

18. A lamp according to claim 17 wherein said first and second studs are threaded, and wherein the lamp further comprises a threaded bushing for interconnecting the first and second studs.

19. A lamp according to claim 18 wherein said bushing is adapted to clamp a small spider ring between the bushing and a fitting.

20. A lamp, comprising, in combination,
a lamp wire and a socket for receiving an illuminating lamp bulb,
first connection means for connection to a large lampshade spider ring,
and second connection means for connection to a small lampshade spider ring,
the second connection means including fittings adapted to route the lamp wire without interruption around the small lampshade spider ring.
